(19) United States
(12) Patent Application Publication
(10) Pub. No.: US 2005/0100682 A1
(43) Pub. Date: May 12, 2005

(54) Method for depositing materials on a substrate

(75) Inventors: Noriaki Fukiage, Hartsdale, NY (US); Katherina Babich, Chappaqua, NY (US)

Correspondence Address: PILLSBURY WINTHROP, LLP, P.O. BOX 10500, MCLEAN, VA, 22102, US

(73) Assignees: Tokyo Electron Limited, Tokyo (JP); International Business Machines Corporation, Armonk, NY (US)

(21) Appl. No.: 10/702,048

(22) Filed: Nov. 6, 2003

(51) Int. Cl. H05H 1/24

(52) U.S. Cl. 427/569; 427/282

(57) ABSTRACT

A method and apparatus for depositing a TERA film having tunable optical and etch resistant properties on a substrate using a plasma-enhanced chemical vapor deposition process, wherein for at least a part of the deposition of the TERA film, the plasma-enhanced chemical vapor deposition process employs a precursor that reduces reaction with a photoresist. The apparatus includes a chamber having an upper electrode coupled to a first RF source and a substrate holder coupled to a second RF source; and a showerhead for providing multiple process and precursor gasses.

### CROSS-REFERENCE TO RELATED APPLICATIONS

This application is related to co-pending U.S. patent application Ser. No. 10/644,958, entitled “Method and Apparatus For Depositing Materials With Tunable Optical Properties And Etching Characteristics”, filed on Aug. 21, 2003; and co-pending United States patent application serial no. (RAJ-014), entitled “Method of Improving Post-Develop Photoresist Profile on a Deposited Dielectric Film”, Attorney docket no. 071469-0305918, filed on even date herewith. The entire contents of these applications are herein incorporated by reference in their entirety.

### FIELD OF THE INVENTION

The present invention relates to using a plasma-enhanced chemical vapor deposition (PECVD) system to deposit thin-film materials with tunable optical and etching characteristics.

### BACKGROUND OF THE INVENTION

Integrated circuit and device fabrication requires deposition of electronic materials on substrates. The deposited film may be a permanent part of the substrate or finished circuit. In this case, the film characteristics are chosen to provide the electrical, physical, or chemical properties required for circuit operation. In other cases, the film may be employed as a temporary layer that enables or simplifies device or circuit fabrication. For example, a deposited film may serve as a mask for subsequent etching processes. The etch-resistant film may be patterned such that it covers areas of the substrate that are not to be removed by the etch process. A subsequent process may then remove the etch-resistant film in order to allow further processing of the substrate.

In another example of a temporary layer, a film may be employed to enhance a subsequent lithographic patterning operation. In one embodiment, a film with specific optical properties is deposited on a substrate, after which the film is coated with a photosensitive imaging film commonly referred to as photoresist. The photoresist is then patterned by exposure to light. The optical properties of the underlying deposited film are chosen to reduce reflection of the exposing light, thereby improving the resolution of the lithographic process. Such a film is commonly referred to as an anti-reflective coating (henceforth: ARC).

In another example of a temporary layer, a film may be employed that acts as both a hard mask and an antireflective coating. Such a film is described in U.S. Pat. No. 6,316,167.

A critical consideration for integrating an ARC and/or hard mask layer in a lithographic process is that the film in contact with the photoresist must not affect the ability of the photoresist to produce the desired post-development profile on the substrate. The resist can be deposited on an anti-reflective coating, on a hard mask, or a film with both anti-reflective and hard mask properties. It may be desirable for the sidewalls of the resist features to be generally smooth and perpendicular to the substrate, and no residual photoresist (footing) be present on the substrate in the areas that were exposed by the lithographic tool.

### SUMMARY OF THE INVENTION

The present invention relates to a deposition process in a PECVD system, and more particularly, to the deposition of a Tunable Etch Resistant ARC (TERA) layer. The present invention provides a method for depositing a TERA layer on a substrate, where at least a part of the TERA layer reduces the reaction of the TERA layer with photoresist

### BRIEF DESCRIPTION OF THE DRAWINGS

In the drawings:

FIG. 1 illustrates a simplified block diagram for a PECVD system in accordance with an embodiment of the present invention;

FIGS. 2A-2C show a simplified procedure for preventing the formation of a photoresist footing on a TERA layer in accordance with an embodiment of the present invention;

FIG. 3 shows a simplified flow diagram of a procedure for depositing a TERA layer comprising a first portion and a second portion on a substrate in accordance with an embodiment of the present invention; and

FIG. 4 shows an exemplary set of processes used in a procedure for depositing a TERA layer comprising a first portion and a second portion on a substrate in accordance with an embodiment of the present invention;

FIGS. 5A-5B show additional exemplary processes used in a procedure for depositing a top layer of a TERA layer on a substrate in accordance with an embodiment of the present invention; and

FIGS. 6A-6B show cross-sectional SEM micrographs of resist features on a TERA layer in accordance with an embodiment of the present invention.

### DETAILED DESCRIPTION OF AN EMBODIMENT

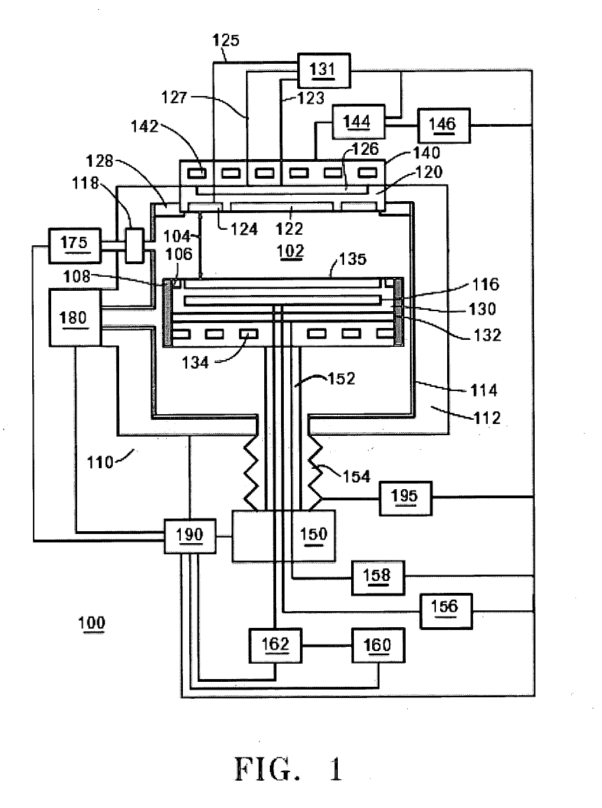

FIG. 1 illustrates a simplified block diagram for a PECVD system in accordance with an embodiment of the present invention. In the illustrated embodiment, PECVD system 100 comprises processing chamber 110, upper electrode 140 as part of a capacitively coupled plasma source, shower plate assembly 120, substrate holder 130 for supporting substrate 135, pressure control system 180, and controller 190. In one embodiment, PECVD system 100 can comprise a remote plasma system 175 that can be coupled to the processing chamber 110 using a valve 178. In another embodiment, a remote plasma system and valve are not required.

In one embodiment, PECVD system 100 can comprise a pressure control system 180 that can be coupled to the processing chamber 110. For example, the pressure control system 180 can comprise a throttle valve (not shown) and a turbomolecular pump (TMP) (not shown) and can provide a controlled pressure in processing chamber 110. In alternate embodiments, the pressure control system can comprise a dry pump. For example, the chamber pressure can range from approximately 0.1 mTorr to approximately 100 Torr. Alternatively, the chamber pressure can range from approximately 0.1 Torr to approximately 20 Torr.

Processing chamber 110 can facilitate the formation of plasma in process space 102. PECVD system 100 can be configured to process substrates of any size, such as 200 mm substrates, 300 mm substrates, or larger substrates. Alternately, the PECVD system 100 can operate by generating plasma in one or more processing chambers.

PECVD system 100 comprises a shower plate assembly 120 coupled to the processing chamber 110. Shower plate assembly is mounted opposite the substrate holder 130. Shower plate assembly 120 comprises a center region 122, an edge region 124, and a sub region 126. Shield ring 128 can be used to couple shower plate assembly 120 to processing chamber 110.

Center region 122 is coupled to gas supply system 131 by a first process gas line 123. Edge region 124 is coupled to gas supply system 131 by a second process gas line 125. Sub region 126 is coupled to gas supply system 131 by a third process gas line 127.

Gas supply system 131 provides a first process gas to the center region 122, a second process gas to the edge region 124, and a third process gas to the sub region 126. The gas chemistries and flow rates can be individually controlled to these regions. Alternately, the center region and the edge region can be coupled together as a single primary region, and gas supply system can provide the first process gas and/or the second process gas to the primary region. In alternate embodiments, any of the regions can be coupled together and the gas supply system can provide one or more process gasses as appropriate.

The gas supply system 131 can comprise at least one vaporizer (not shown) for providing precursors. Alternately, a vaporizer is not required. In an alternate embodiment, a bubbling-system can be used.

PECVD system 100 comprises an upper electrode 140 that can be coupled to shower plate assembly 120 and coupled to the processing chamber 110. Upper electrode 140 can comprise temperature control elements 142. Upper electrode 140 can be coupled to a first RF source 146 using a first match network 144. Alternately, a separate match network is not required.

The first RF source 146 provides a TRF signal to the upper electrode, and the first RF source 146 can operate in a frequency range from approximately 0.1 MHz. to approximately 200 MHz. The TRF signal can be in the frequency range from approximately 1 MHz. to approximately 100 MHz, or alternatively in the frequency range from approximately 2 MHz. to approximately 60 MHz. The first RF source can operate in a power range from approximately 0 watts approximately 10000 watts, or alternatively the first RF source operates in a power range from approximately 0 watts to approximately 5000 watts.

Upper electrode 140 and RF source 146 are parts of a capacitively coupled plasma source. The capacitively couple plasma source may be replaced with or augmented by other types of plasma sources, such as an inductively coupled plasma (ICP) source, a transformer-coupled plasma (TCP) source, a microwave powered plasma source, an electron cyclotron resonance (ECR) plasma source, a Helicon wave plasma source, and a surface wave plasma source. As is well known in the art, upper electrode 140 may be eliminated or reconfigured in the various suitable plasma sources.

Substrate 135 can be, for example, transferred into and out of processing chamber 110 through a slot valve (not shown) and chamber feed-through (not shown) via robotic substrate transfer system (not shown), and it can be received by substrate holder 130 and mechanically translated by devices coupled thereto. Once substrate 135 is received from substrate transfer system, substrate 135 can be raised and/or lowered using a translation device 150 that can be coupled to substrate holder 130 by a coupling assembly 152.

Substrate 135 can be affixed to the substrate holder 130 via an electrostatic clamping system. For example, an electrostatic clamping system can comprise an electrode 117 and an ESC supply 156. Clamping voltages, that can range from approximately −2000 V to approximately +2000 V, for example, can be provided to the clamping electrode. Alternatively, the clamping voltage can range from approximately −1000 V to approximately +1000 V. In alternate embodiments, an ESC system and supply is not required.

Substrate holder 130 can comprise lift pins (not shown) for lowering and/or raising a substrate to and/or from the surface of the substrate holder. In alternate embodiments, different lifting means can be provided in substrate holder 130. In alternate embodiments, gas can, for example, be delivered to the backside of substrate 135 via a backside gas system to improve the gas-gap thermal conductance between substrate 135 and substrate holder 130.

A temperature control system can also be provided. Such a system can be utilized when temperature control of the substrate is required at elevated or reduced temperatures. For example, a heating element 132, such as resistive heating elements, or thermoelectric heaters/coolers can be included, and substrate holder 130 can further include a heat exchange system 134. Heating element 132 can be coupled to heater supply 158. Heat exchange system 134 can include a re-circulating coolant flow means that receives heat from substrate holder 130 and transfers heat to a heat exchanger system (not shown), or when heating, transfers heat from the heat exchanger system.

Also, electrode 116 can be coupled to a second RF source 160 using a second match network 162. Alternately, a match network is not required.

The second RF source 160 provides a bottom RF signal (BRF) to the lower electrode 116, and the second RF source 160 can operate in a frequency range from approximately 0.1 MHz. to approximately 200 MHz. The BRF signal can be in the frequency range from approximately 0.2 MHz. to approximately 30 MHz, or alternatively, in the frequency range from approximately 0.3 MHz. to approximately 15 MHz. The second RF source can operate in a power range from approximately 0.0 watts to approximately 1000 watts, or alternatively, the second RF source can operate in a power range from approximately 0.0 watts to approximately 500 watts. in various embodiments, the lower electrode 116 may be not used, or may be the sole source of plasma within the chamber, or may augment any additional plasma source.

PECVD system 100 can further comprise a translation device 150 that can be coupled by a bellows 154 to the processing chamber 110. Also, coupling assembly 152 can couple translation device 150 to the substrate holder 130. Bellows 154 is configured to seal the vertical translation device from the atmosphere outside the processing chamber 110.

Translation device 150 allows a variable gap 104 to be established between the shower plate assembly 120 and the substrate 135. The gap can range from approximately 1 mm to approximately 200 mm, and alternatively, the gap can range from approximately 2 mm to approximately 80 mm. The gap can remain fixed or the gap can be changed during a deposition process.

Additionally, substrate holder 130 can further comprise a focus ring 106 and ceramic cover 108. Alternately, a focus ring 106 and/or ceramic cover 108 are not required.

At least one chamber wall 112 can comprise a coating 114 to protect the wall. For example, the coating 114 can comprise a ceramic material. In an alternate embodiment, a coating is not required. Furthermore, a ceramic shield (not shown) can be used within processing chamber 110.

In addition, the temperature control system can be used to control the chamber wall temperature. For example, ports can be provided in the chamber wall for controlling temperature. Chamber wall temperature can be maintained relatively constant while a process is being performed in the chamber.

Also, the temperature control system can be used to control the temperature of the upper electrode. Temperature control elements 142 can be used to control the upper electrode temperature. Upper electrode temperature can be maintained relatively constant while a process is being performed in the chamber.

In addition, PECVD system 100 can also comprise a remote plasma system 175 that can be used for chamber cleaning.

Furthermore, PECVD system 100 can also comprise a purging system 195 that can be used for controlling contamination and/or chamber cleaning.

In an alternate embodiment, processing chamber 110 can, for example, further comprise a monitoring port (not shown). A monitoring port can, for example, permit optical monitoring of process space 102.

PECVD system 100 also comprises a controller 190. Controller 190 can be coupled to chamber 110, shower plate assembly 120, substrate holder 130, gas supply system 131, upper electrode 140, first RF match 144, first RF source 146, translation device 150, ESC supply 156, heater supply 158, second RF match 162, second RF source 160, purging system 195, remote plasma device 175, and pressure control system 180. The controller can be configured to provide control data to these components and receive data such as process data from these components. For example, controller 190 can comprise a microprocessor, a memory, and a digital I/O port capable of generating control voltages sufficient to communicate and activate inputs to the processing system 100 as well as monitor outputs from the PECVD system 100. Moreover, the controller 190 can exchange information with system components. Also, a program stored in the memory can be utilized to control the aforementioned components of a PECVD system 100 according to a process recipe. In addition, controller 190 can be configured to analyze the process data, to compare the process data with target process data, and to use the comparison to change a process and/or control the deposition tool. Also, the controller can be configured to analyze the process data, to compare the process data with historical process data, and to use the comparison to predict, prevent, and/or declare a fault.

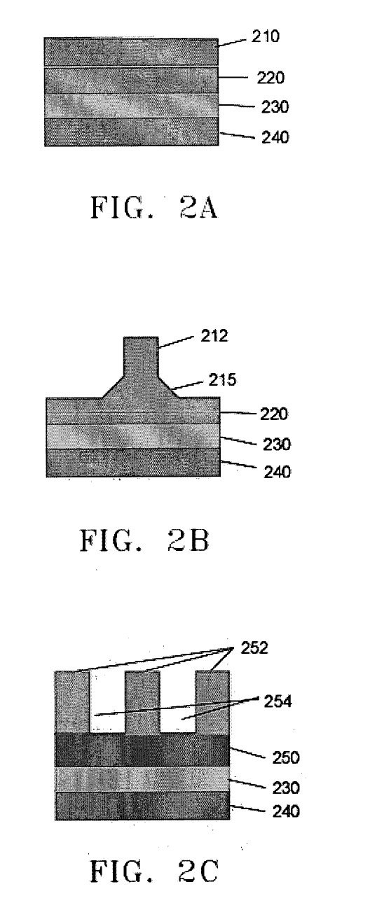

FIGS. 2A-2C show a simplified procedure for preventing the formation of a photoresist footing on a TERA layer in accordance with an embodiment of the present invention. FIG. 2A shows a photoresist layer 210 on a TERA layer, which comprises a top layer 220 and a bottom layer 230. For example, the top layer 220 of the TERA layer can be a layer having a thickness of approximately 150 A to approximately 1000 A, and the bottom layer 230 of the TERA layer can be a layer having a thickness of approximately 300 A to approximately 5000 A. In this example, the TERA bottom layer 230 is coupled to an oxide layer 240. This is not required, and the TERA layer may be deposited on materials other than oxide. Although two layers are shown in FIGS. 2A-2C, this is not required. A TERA stack can comprise one or more layers.

In FIG. 2B, the photoresist layer 210 has been processed using at least one lithography step and at least one development step. FIG. 2B shows a photoresist feature 212 on a TERA layer, which comprises a top layer 220 and a bottom layer 230. Also, a photoresist footing 215 is shown at the base of the photoresist feature 212. For example, a photoresist footing can be caused by an interaction between the top layer 220 of the TERA layer and the photoresist layer 210. Resist footing can be caused by a reaction between the TERA layer material and the substrate material and/or out-gassing from the substrate. Photoresist footings can cause problems during the subsequent steps in the processing of the substrate and should be prevented from forming. Top layer 220 and bottom layer 230 of the TERA layer can be the same.

In FIG. 2C, the photoresist layer 210 has been processed using the method of the present invention. FIG. 2C shows a layer 250 and a well-defined photoresist feature 252 and well-defined openings 254 in the photoresist on the layer 250 of the TERA layer that was deposited using the method of the present invention. As shown in FIG. 2C, the features 252 and the openings 254 have rectangular shapes, but this is not required. In alternate embodiments, square shaped features and/or openings can be present.

In this example, the TERA bottom layer 230 is coupled to an oxide layer 240. This is not required, and the TERA layer may be deposited on materials other than oxide. Although two layers (230 and 250) are shown in FIG. 2C, this is not required. A TERA stack can comprise one or more layers. For example, a single layer, such as layer 250 can be used.

The inventors believe that the resist footing can limit the ability of a resist material to accurately image nanostructures on a substrate and the resist footing can also adversely affect the CD measurements. The inventors have developed methods for minimizing and/or eliminating the resist footing.

The inventors also believe that the photoresist footing may be caused by a chemical interaction at the interface between the ARC and photoresist, commonly referred to as resist poisoning. For example, amine-based species present at the top surface of the ARC layer may react with a chemically amplified photoresist and reduce the photoresist development rate near the resist-substrate interface. This may prevent complete resist dissolution during the development step, thereby producing resist footing. The inventors have developed methods to ensure that the top surface of the TERA layer (i.e., the surface in direct contact with the photoresist) does not react with the resist in such away that it adversely alters the resist development characteristics.

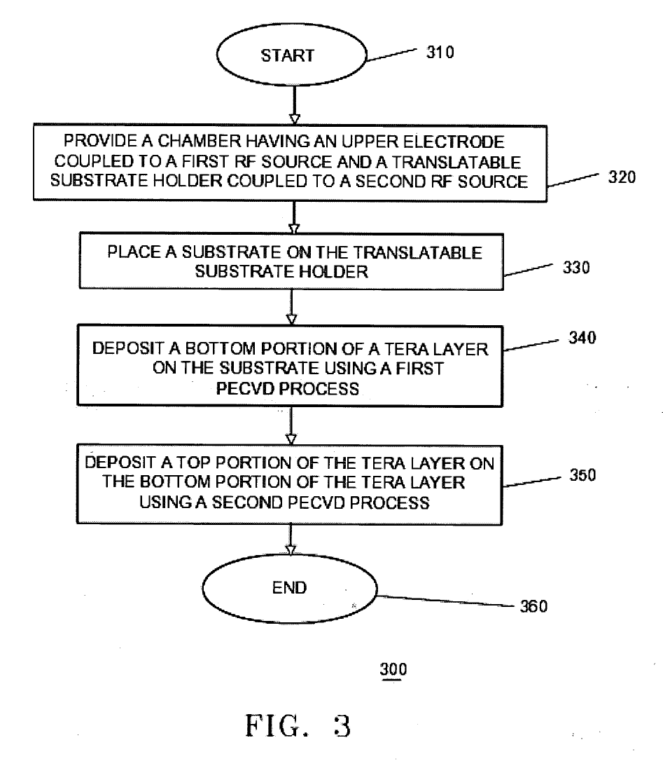

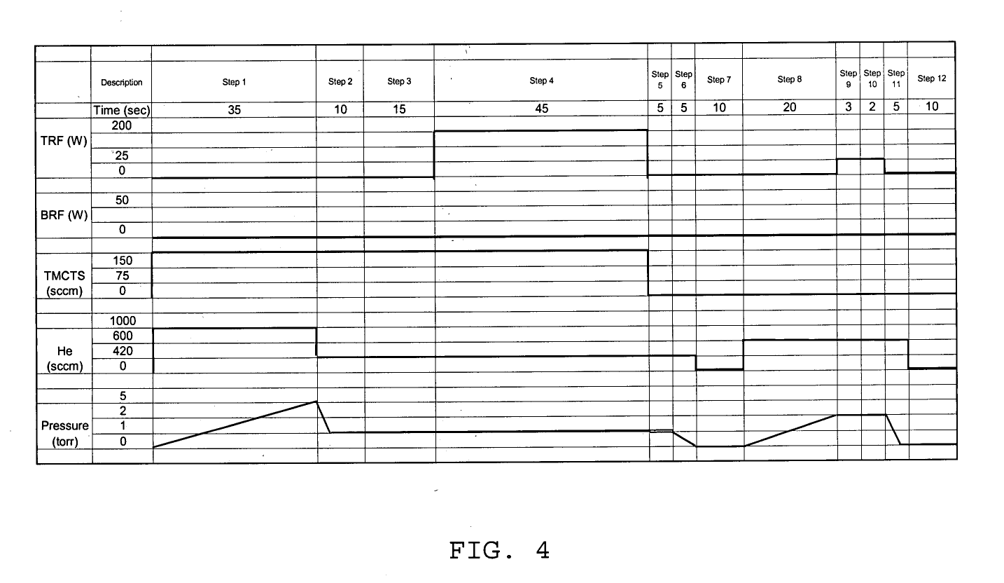

FIG. 3 shows a simplified flow diagram of a procedure for depositing a TERA layer comprising a top layer and a bottom layer on a substrate in accordance with an embodiment of the present invention. For example, the bottom layer of a TERA layer can be deposited using a first process and the top layer of the TERA layer can be deposited using a different process. Procedure 300 starts in 310.

In 320, a chamber can be provided, and the chamber can comprise a plasma source and an optionally translatable substrate holder coupled to a second RF source.

In 330, a substrate is placed on the translatable substrate holder. For example, the translatable substrate holder can be used to establish a gap between an upper electrode surface and a surface of the translatable substrate holder. The gap can range from approximately 1 mm to approximately 200 mm, or alternatively, the gap can range from approximately 2 mm to approximately 80 mm. In alternate embodiments, the gap size can be changed.

In 340, the bottom layer of the TERA layer can be deposited on the substrate.

During the bottom layer deposition process, a TRF signal can be provided to the upper electrode using the first RF source. For example, the first RF source can operate in a frequency range from approximately 0.1 MHz. to approximately 200 MHz. Alternatively, the first RF source can operate in a frequency range from approximately 1 MHz. to approximately 100 MHz, or the first RF source can operate in a frequency range from approximately 2 MHz. to approximately 60 MHz. The first RF source can operate in a power range from approximately 10 watts to approximately 10000 watts, or alternatively, the first RF source can operate in a power range from approximately 10 watts to approximately 5000 watts.

Also, during the bottom layer deposition process, a BRF signal can be provided to the lower electrode using the second RF source. For example, the second RF source can operate in a frequency range from approximately 0.1 MHz. to approximately 200 MHz. Alternatively, the second RF source can operate in a frequency range from approximately 0.2 MHz. to approximately 30 MHz, or the second RF source can operate in a frequency range from approximately 0.3 MHz. to approximately 15 MHz. The second RF source can operate in a power range from approximately 0.0 watts to approximately 1000 watts, or alternatively, the second RF source can operate in a power range from approximately 0.0 watts to approximately 500 watts. In an alternate embodiment, a BRF signal is not required.

In addition, a shower plate assembly can be provided in the processing chamber and can be coupled to the upper electrode. The shower plate assembly can comprise a center region, an edge region and a sub region, and the shower plate assembly can be coupled to a gas supply system. A first process gas can be provided to the center region, a second process gas can be provided to the edge region and a third process gas can be provided to the sub region during the bottom layer deposition process.

Alternately, the center region and the edge region can be coupled together as a single primary region, and gas supply system can provide the first process gas and/or the second process gas to the primary region. In alternate embodiments, any of the regions can be coupled together and the gas supply system can provide one or more process gasses.

The first process gas can comprise at least one of a silicon-containing precursor and a carbon-containing precursor. An inert gas can also be included. For example, the flow rate for the silicon-containing precursor and the carbon-containing precursor can range from approximately 0.0 sccm to approximately 5000 sccm and the flow rate for the inert gas can range from approximately 0.0 sccm to approximately 10000 sccm. The silicon-containing precursor can comprise at least one of monosilane (SiH₄), tetraethylorthosilicate (TEOS), monomethylsilane (1MS), dimethylsilane (2MS), trimethylsilane (3MS), tetramethylsilane (4MS), octamethylcyclotetrasiloxane (OMCTS), and tetramethylcyclotetrasilane (TMCTS). The carbon-containing precursor can comprise at least one of CH₄, C₂H₄, C₂H₂, C₆H₆ and C₆H₅OH. The inert gas can be argon, helium, and/or nitrogen.

The second process gas can comprise at least one of a silicon-containing precursor and a carbon-containing precursor. An inert gas can also be included. For example, the flow rate for the silicon-containing precursor and the carbon-containing precursor can range from approximately 0.0 sccm to approximately 5000 sccm and the flow rate for the inert gas can range from approximately 0.0 sccm to approximately 10000 sccm. The silicon-containing precursor can comprise at least one of monosilane (SiH₄), tetraethylorthosilicate (TEOS), monomethylsilane (1MS), dimethylsilane (2MS), trimethylsilane (3MS), tetramethylsilane (4MS), octamethylcyclotetrasiloxane (OMCTS), and tetramethylcyclotetrasilane (TMCTS). The carbon-containing precursor can comprise at least one of CH₄, C₂H₄, C₂H₂, C₆H₆ and C₆H₅OH. The inert gas can comprise at least one of argon, helium, and nitrogen.

In addition, the third process gas can comprise at least one of an oxygen containing gas, a nitrogen containing gas, a carbon-containing gas, and an inert gas. For example, the oxygen containing gas can comprise at least one of O₂, CO, NO, N₂O, and CO₂; carbon-containing precursor can comprise at least one of CH₄, C₂H₄, C₂H₂, C₆H₆ and C₆H₅OH; the nitrogen containing gas can comprise at least one of N₂, and NF₃; and the inert gas can comprise at least one of Ar, and He. The flow rate for the third process gas can range from approximately 0.0 sccm to approximately 10000 sccm.

The flow rates for the first process gas and the second process gas can be independently established during the deposition of the bottom layer.

The bottom layer can comprise a material having a refractive index (n) ranging from approximately 1.5 to approximately 2.5 when measured at a wavelength of at least one of: 248 nm, 193 nm, and 157 nm, and an extinction coefficient (k) ranging from approximately 0.10 to approximately 0.9 when measured at a wavelength of at least one-of: 248 nm, 193 mm, and 157 nm. The bottom layer can comprise a thickness ranging from approximately 30.0 nm to approximately 500.0 nm, and the deposition rate can range from approximately 100 A/min to approximately 10000 A/min. The bottom layer deposition time can vary from approximately 5 seconds to approximately 180 seconds.

Furthermore, the chamber pressure and substrate temperature can be controlled during the deposition of the bottom layer. For example, the chamber pressure can range from approximately 0.1 mTorr to approximately 100.0 Torr, and the substrate temperature can range from approximately 0° C. to approximately −500 C.

In 350, a top layer can be deposited on the bottom layer.

During the deposition of the top layer of the TERA layer, a TRF signal can be provided to the upper electrode using the first RF source. For example, the first RF source can operate in a frequency range from approximately 0.1 MHz. to approximately 200 MHz. Alternatively, the first RF source can operate in a frequency range from approximately 1 MHz. to approximately 100 MHz, or the first RF source can operate in a frequency range from approximately 2 MHz. to approximately 60 MHz. The first RF source can operate in a power range from approximately 10 watts to approximately 10000 watts, or the first RF source can operate in a power range from approximately 10 watts to approximately 5000 watts.

In addition, a shower plate assembly can be provided in the processing chamber and can be coupled to the upper electrode. The shower plate assembly can comprise a center region and an edge region, and the shower plate assembly can be coupled to a gas supply system. A first process gas can be provided to the center region, a second process gas can be provided to the edge region, and a third process gas can be provided to the chamber through third gas region during the top layer deposition process.

Alternately, the center region and the edge region can be coupled together as a single primary region, and gas supply system can provide the first process gas and/or the second process gas to the primary region. In alternate embodiments, any of the regions can be coupled together and the gas supply system can provide one or more process gasses.

The first process gas can comprise a precursor that includes silicon, carbon and oxygen. An inert gas can also be included. For example, the flow rate for the precursor can range from approximately 0.0 sccm to approximately 5000 sccm and the flow rate for the inert gas can range from approximately 0.0 sccm to approximately 10000 sccm. The precursor can comprise at least one of tetraethylorthosilicate (TEOS), tetramethylcyclotetrasilane (TMCTS), dimethyldimethoxysilane (DMDMOS), and octamethylcyclotetrasiloxane (OMCTS), and the inert gas can comprise at least one of argon, helium, and nitrogen.

The second-process gas can comprise a precursor that includes silicon, carbon and oxygen. An inert gas can also be included. For example, the flow rate for the precursor can range from approximately 0.0 sccm to approximately 5000 sccm and the flow rate for the inert gas can range from approximately 0.0 sccm to approximately 10000 sccm. The precursor can comprise at least one of tetraethylorthosilicate (TEOS), tetramethylcyclotetrasilane (TMCTS), dimethyldimethoxysilane (DMDMOS), and octamethylcyclotetrasiloxane (OMCTS), and the inert gas can comprise at least one of argon, helium, and nitrogen.

The flow rate for the third process gas can range from approximately 0.0 sccm to approximately 10000 sccm. The third process gas can comprise at least one of an oxygen containing gas, a nitrogen containing gas, and an inert gas. The oxygen containing gas can comprise at least one of O₂, CO, NO, N₂O, and CO₂. The nitrogen containing gas can comprise at least one of N₂, and NF₃. The inert gas can comprise at least one of Ar and He.

In an alternate embodiment, the first process gas and the second process gas can comprise a silicon-containing precursor, a carbon-containing gas, and an oxygen-containing gas. An inert gas can also be included. For example, the silicon-containing precursor can comprise at least one of monosilane (SiH₄), tetraethylorthosilicate (TEOS), monomethylsilane (1MS), dimethylsilane (2MS), trimethylsilane (3MS), and tetramethylsilane (4MS). Also, the carbon-containing precursor can comprise at least one of CH₄, C₂H₄, C₂H₂, C₆H₆ and C₆H₅OH. The oxygen containing gas can comprise at least one of O₂, CO, NO, N₂O, and CO₂ In addition, the chamber pressure can be lower than approximately 3 Torr and/or the substrate temperature can be greater than approximately 300° C.

Procedure 300 ends in 360. The top layer can comprise a material having a refractive index (n) ranging from approximately 1.5 to approximately 2.5 when measured at a wavelength of at least one of: 248 nm, 193 nm, and 157 nm, and an extinction coefficient (k) ranging from approximately 0.10 to approximately 0.9 when measured at a wavelength of at least one of: 248 nm, 193 nm, and 157 nm.

The top layer can comprise a thickness ranging from approximately 150 A to approximately 1000 A, and the deposition rate can range from approximately 10 A/min to approximately 5000 A/min. The top layer deposition time can vary from approximately 5 seconds to approximately 200 seconds. In addition, the top layer does not cause a footing by not reacting with the photoresist and by preventing the out-gassing of material from the layer below the TERA layer.

In an alternate embodiment, a BRF signal can be provided to the lower electrode using the second RF source during the top layer deposition process. For example, the second RF source can operate in a frequency range from approximately 0.1 MHz. to approximately 200 MHz. Alternatively, the second RF source can operate in a frequency range from approximately 0.2 MHz. to approximately 30 MHz, or the second RF source can operate in a frequency range from approximately 0.3 MHz. to approximately 15 MHz. The second RF source can operate in a power range from approximately 0.0 watts to approximately 1000 watts. Alternatively, the second RF source operates in a power range from approximately 0.0 watts to approximately 500 watts. A pressure control system can be coupled to the chamber, and the chamber pressure can be controlled using the pressure control system. For example, the chamber pressure can range from approximately 0.1 mTorr to approximately 100 Torr. A temperature control system can be coupled to the substrate holder, and the substrate temperature can be controlled using the temperature control system. For example, the substrate temperature can range from approximately 0° C. to approximately 500° C. The temperature control system can also be coupled to a chamber wall, and the temperature of the chamber wall can be controlled using the temperature control system. For example, the temperature of the chamber wall can range from approximately 0° C. to approximately 500° C. In addition, the temperature control system can be coupled to the shower plate assembly; and the temperature of the shower plate assembly can be controlled using the temperature control system. For example, the temperature of the shower plate assembly can range from approximately 0° C. to approximately 500° C.

In an alternative embodiment, the deposition of the bottom portion of the TERA layer at 340 can be the same as the deposition of the top portion of the TERA layer at 350. That is, the TERA layer can be substantially uniform.

FIG. 4 shows an exemplary set of processes used in a procedure for depositing a top layer of a TERA layer on a substrate in accordance with an embodiment of the present invention. In alternate embodiments, a different set of processes can be used.

In the first step, processing gases are introduced into the chamber, and an operating pressure is established. For example, the chamber pressure can be changed to at approximately 5 Torr, and the duration of the first step can be approximately thirty-five seconds. The processing gases can include a precursor that includes silicon, carbon and oxygen, such as TMCTS, and an inert gas. For example, the flow rate for the precursor can be approximately 150 sccm, and the flow rate for the inert gas can be approximately 1000 sccm. In alternate embodiments, different pressures, different flow rates, different gases, different precursors, and different durations can be used.

In the second step, the flow rate for the inert gas and the chamber pressure can be changed. For example, the flow rate for the inert gas can be changed to approximately 420 sccm, and the chamber pressure can be changed to approximately 1 Torr.

In the third step, a stabilization process can be performed. For example, the flow rate of the precursor, the flow rate of the inert gas, and the chamber pressure can be held substantially constant.

In the fourth step, the top layer of the TERA layer can be deposited. A first RF source can provide an RF signal (TRF) to the upper electrode. The TRF frequency can be in the range from approximately 0.1 MHz to approximately 200 MHz and the TRF power can be in the range from approximately 10 watts to approximately 10000 watts. For example, the TRF power can be approximately 200 watts.

In an alternate embodiment, a BRF signal can be provided in which the frequency can be in the range from approximately 0.1 MHz to approximately 200 MHz add the BRF power can be in the range from approximately 0 watts to approximately 1000 watts.

In the fifth step, the TRF signal level can be altered, the processing gasses can be changed, and flow rates can be modified. In the illustrated embodiment (FIG. 4), the TRF signal was turned off; the precursor flow rate was changed to approximately 0.0 sccm, and the flow rate of the inert gas was held constant.

In the sixth step, the TRF signal can remain off, the chamber pressure can be changed, and flow rate for the inert gas can be kept substantially constant. In the illustrated embodiment (FIG. 4), the chamber pressure was lowered.

In the seventh step, a purging process can be performed. For example, the flow rate of the inert gas can be changed, and the chamber pressure can be held low.

In the eighth step, the chamber pressure can be increased, and an inert gas can be provided in the chamber. In the illustrated embodiment (FIG. 4), the RF signal is off; the flow rate of the inert gas was set to approximately 600 sccm; and the chamber pressure was increased to approximately 2 Torr.

In the ninth and tenth steps, a discharge sequence can be performed. In the illustrated embodiment (FIG. 4), the TRF signal was turned on; the flow rate of the silicon-containing precursor gas was set to zero; the flow rate of the inert gas was set to approximately 600 sccm; and the chamber pressure was maintained at approximately 2 Torr. In addition, a pin up process can be performed. For example, the lift pins can be extended to lift the substrate off the substrate holder. In addition, an RF signal can be provided during at least a portion of the pin up process.

In the eleventh step, a purging process can be performed. For example, the TRF signal can be altered, and the chamber pressure can be changed. In the illustrated embodiment (FIG. 4), the TRF signal was turned off; the flow rate of the silicon-containing precursor gas was set to zero; the flow rate of the inert gas was set to approximately 600 sccm; and the chamber pressure was decreased from approximately 2 Torr.

In the twelfth step, the chamber is evacuated and the pressure remains low. For example, processing gas is not provided to the chamber during this step.

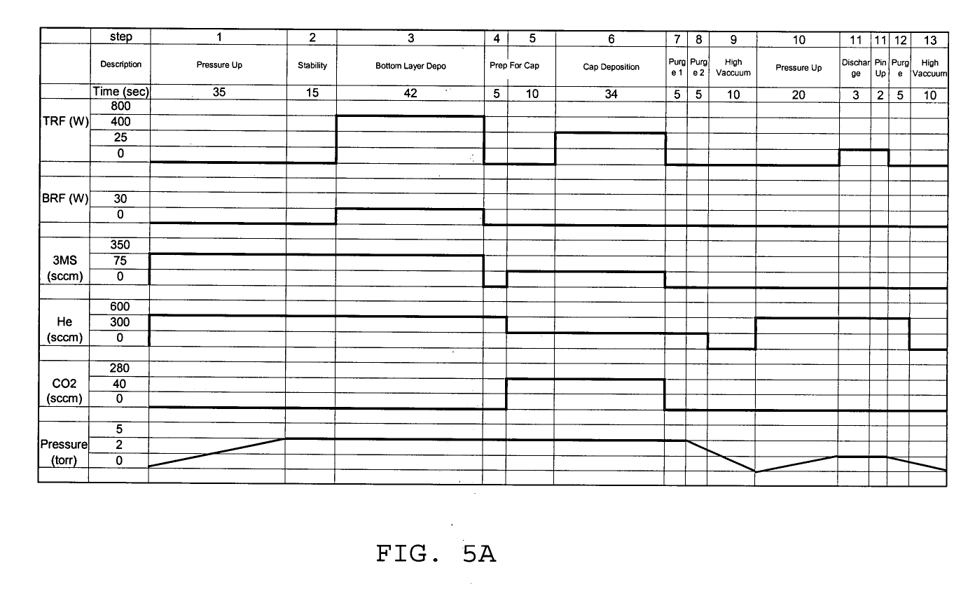

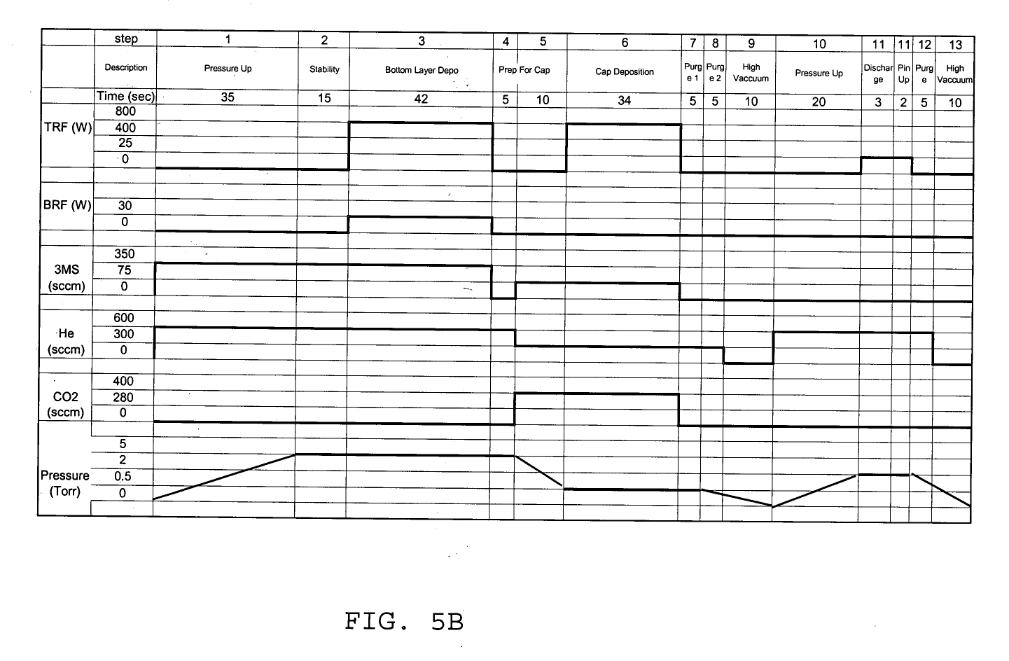

FIGS. 5A-5B show additional exemplary processes used in a procedure for depositing portions of a TERA layer on a substrate in accordance with an embodiment of the present invention. In the first step, processing gases can be introduced into the chamber, and an operating pressure can be established. For example, the chamber pressure can be changed to approximately 5 Torr, and the duration of the first step can be approximately thirty-five seconds. The processing gases can include a precursor that includes silicon, such as 3MS, and an inert gas. For example, the flow rate for the precursor can be approximately 350 sccm, and the flow rate for the inert gas can be approximately 600 sccm. In alternate embodiments, different pressures, different flow rates, different gases, different precursors, and different durations can be used.

In the second step, a stabilization process can be performed. For example, the flow rate of the precursor, the flow rate of the inert gas, and the chamber pressure can be held substantially constant.

In the third step, the bottom layer of the TERA layer can be deposited. A first RF source can provide an RF signal (TRF) to the upper electrode. The TRF frequency can be in the range from approximately 0.1 MHz to approximately 200 MHz and the TRF power can be in the range from approximately 10 watts to approximately 10000 watts. For example, the TRF power can be approximately 800 watts. In addition, a BRF signal can be provided in which the frequency can be in the range from approximately 0.1 MHz to approximately 200 MHz and the BRF power can be in the range from approximately 0 watts to approximately 1000 watts. For example, the BRF power can be approximately 30 watts.

In the fourth step, the TRF power and the BRF power can be changed to approximately 0 watts. In addition, the flow rate for the precursor can be lowered to approximately 0 sccm.

In the fifth step, the flow rate for the precursor can be changed to approximately 75 sccm; the flow rate for the inert gas can be changed to approximately 300 sccm; and the flow rate for the carbon/oxygen-containing gas can be changed to approximately 400 sccm. In alternate embodiments (FIG. 5B), the pressure can be lowered.

In the sixth step, the top layer of the TERA layer can be deposited. A first RF source can provide an RF signal (TRF) to the upper electrode. The TRF frequency can be in the range from approximately 0.1 MHz to approximately 200 MHz and the TRF power can be in the range from approximately 10 watts to approximately 10000 watts. For example, the TRF power can be approximately 800 watts.

In the seventh step, the TRF power can be changed to approximately o watts; the flow rate for the carbon/oxygen-containing gas can be changed to approximately 0 sccm; the precursor flow rate can be changed to approximately 0.0 sccm; and the flow rate of the inert gas can be held constant.

In the eighth step, the chamber pressure can be lowered, and an inert gas can be provided in the chamber.

In the ninth step, the chamber pressure can be lowered, and the inert gas flow rate can be changed to approximately 0 sccm.

In the tenth step, the chamber pressure can be increased, and an inert gas can be provided in the chamber. For example, the RF signal can be off; the flow rate of the inert gas was set to approximately 600 sccm; and the chamber pressure was increased to approximately 2 Torr.

In the eleventh and twelfth steps, an discharge sequence can be performed. In the illustrated embodiment (FIG. 4), the TRF signal was turned on; the flow rate of the silicon-containing precursor gas was set to zero; the flow rate of the inert gas was set to approximately 600 sccm; and the chamber pressure was maintained at approximately 2 Torr. In addition, a pin up process can be performed. For example, the lift pins can be extended to lift the substrate off the substrate holder. In addition, an RF signal can be provided during at least a portion of the pin up process.

In the thirteenth step, a purging process can be performed. For example, the TRF signal can be altered, and the chamber pressure can be changed. In the illustrated embodiment (FIG. 4), the TRF signal was turned off; the flow rate of the silicon-containing precursor gas was set to zero; the flow rate of the inert gas was set to approximately 600 sccm; and the chamber pressure was decreased from approximately 2 Torr.

In the fourteenth step, the chamber is evacuated and the pressure remains low. For example, processing gas is not provided to the chamber during this step.

In the above examples, the top portions of a TERA layer reduces or even substantially prevent footings by reducing or substantially preventing reactions with the photoresist and by reducing or substantially preventing the out-gassing of material from the layer below the TERA layer.

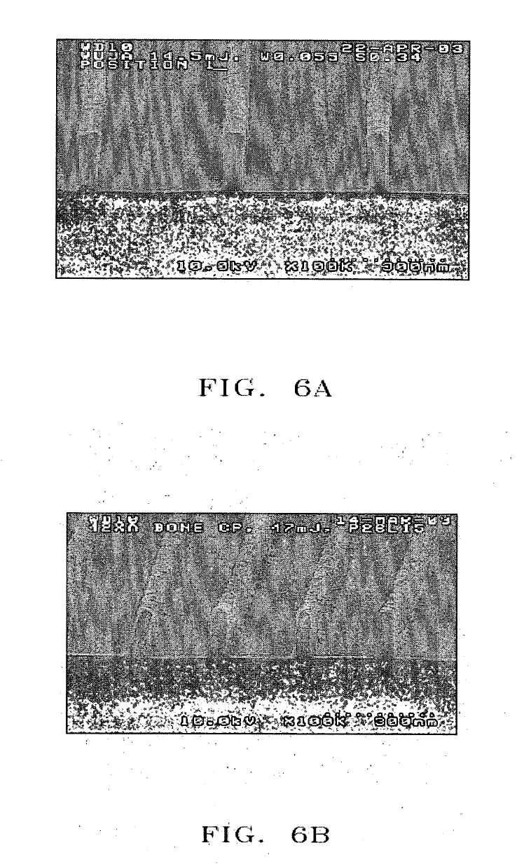

FIGS. 6A-6B show cross-sectional SEM micrographs of resist features on a TERA layer in accordance with an embodiment of the present invention. FIG. 6A shows the process results for resist A on a TERA layer and FIG. 6B shows the process results for resist B on a TERA layer. FIGS. 6A & 6B show that the resist footings are substantially small or have even been substantially eliminated. Note that the photoresist features present substantially rectangular profiles. The resist footings are substantially small because at least the top of the TERA layer is matched with the photoresist layer to reduce reactions therebetween.

In one embodiment, TERA bottom layer and top layer can be deposited sequentially in one chamber. During the period between bottom and top layer deposition, the plasma is turned off. In an alternate embodiment, TERA bottom layer and top layer can be deposited sequentially in the same chamber without turning off the plasma. In another embodiment, TERA bottom layer and top layer can be deposited in separate chambers.

In one embodiment, the chamber is kept at a specific pressure between bottom layer and top layer deposition. In an alternate embodiment, the chamber may be evacuated between the depositions of the layers.

Although only certain exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

1. A method for depositing a material on a substrate, the method comprising:
placing a substrate in a chamber having a plasma source and on a substrate holder;
depositing a Tunable Etch Resistant ARC (TERA) layer on the substrate, by providing a processing gas comprising at least for a portion of the depositing a precursor, wherein the precursor is chosen to reduce reaction with a photoresist.

2. The method as claimed in claim 1, further comprising:
forming a plurality of photoresist features on the TERA layer, wherein at least one of the photoresist features comprises a substantially small foot.

3. The method as claimed in claim 1, further comprising:
forming a plurality of photoresist features on the TERA layer, wherein at least one of the photoresist features comprises a substantially rectangular profile.

4. The method as claimed in claim 1, further comprising:
matching at least a top portion of the TERA layer and a photoresist layer to prevent the formation of footings on the photoresist features; and
forming the photoresist layer on the top portion, the photoresist layer comprising a plurality of substantially rectangular features.

5. The method as claimed in claim 1, wherein the depositing of the TERA layer includes:
isolating a bottom portion of the TERA layer from a photoresist layer with a top portion of the TERA layer, thereby reducing the formation of footings on photoresist features in a photoresist layer.

6. The method as claimed in claim 1, wherein the depositing of the TERA layer includes:
providing a chemically inactive layer between a chemically active layer and a photoresist layer, wherein the precursor is chosen to create a dielectric material that does not chemically react with the photoresist layer.

7. The method as claimed in claim 1, wherein the depositing of the TERA layer includes:
configuring at least a top portion of the TERA layer to have a chemically inert surface, wherein a plurality of photoresist features having substantially rectangular profiles can be formed on the chemically inert surface.

8. The method as claimed in claim 1, wherein the depositing of the TERA layer includes:
configuring at least a top portion of the TERA layer to reduce resist poisoning, wherein a plurality of photoresist features having substantially rectangular profiles can be formed on the TERA layer.

9. The method as claimed in claim 1, wherein the depositing of the TERA layer comprises:
depositing a bottom portion of the TERA layer during a deposition time, wherein the bottom portion comprises a material having a refractive index (n) ranging from approximately 1.5 to approximately 2.5 when measured at a wavelength of at least one of: 248 nm, 193 nm, and 157 nm, and an extinction coefficient (k) ranging from approximately 0.10 to approximately 0.9 when measured at a wavelength of at least one of: 248 nm, 193 nm, and 157 nm.

10. The method as claimed in claim 9, wherein the bottom portion has a thickness ranging from approximately 30.0 nm to approximately 400.0 nm.

11. The method as claimed in claim 9, wherein the depositing of the bottom portion occurs at a rate from approximately 100 A/min to approximately 10000 A/min.

12. The method as claimed in claim 9, wherein the deposition time is within the range from approximately 5 seconds to approximately 180 seconds.

13. The method as claimed in claim 9, wherein the plasma source includes an RF source and the depositing of the bottom portion further comprises:
operating the RF source in a frequency range from approximately 0.1 MHz. to approximately 200 MHz; and
operating the RF source in a power range from approximately 10 watts to approximately 10000 watts.

14. The method as claimed in claim 13, wherein a second RF source is coupled to the substrate holder and the depositing of the bottom portion further comprises:
operating the second RF source in a frequency range from approximately 0.1 MHz. to approximately 200 MHz; and
operating the second RF source in a power range from approximately 0.0 watts to approximately 500 watts.

15. The method as claimed in claim 9, wherein the bottom portion is deposited by providing another processing gas comprising at least one of a silicon-containing precursor and a carbon-containing precursor.

16. The method as claimed in claim 15, wherein the providing of the another processing gas comprises flowing the silicon-containing precursor and/or the carbon-containing precursor at a rate ranging from approximately 0.0 sccm to approximately 5000 sccm.

17. The method as claimed in claim 15, wherein the another processing gas comprises at least one of monosilane (SiH₄), tetraethylorthosilicate (TEOS), monomethylsilane (1MS), dimethylsilane (2MS), trimethylsilane (3MS), tetramethylsilane (4MS), octamethylcyclotetrasiloxane (OMCTS), and tetramethylcyclotetrasilane (TMCTS).

18. The method as claimed in claim 15, wherein the another processing gas comprises at least one of CH₄, C₂H₄, C₂H₂, C₆H₆ and C₆H₅OH.

19. The method as claimed in claim 15, wherein the another processing gas includes an inert gas comprising at least one of argon, helium, and nitrogen.

20. The method as claimed in claim 9, wherein the depositing of the bottom portion further comprises:
controlling chamber pressure in a range from approximately 0.1 mTorr to approximately 100 Torr.

21. The method as claimed in claim 20, wherein the chamber pressure ranges from approximately 0.1 mTorr to approximately 20 Torr.

22. The method as claimed in claim 9, wherein the depositing of the bottom portion further comprises:
providing a DC voltage to an electrostatic chuck (ESC) coupled to the substrate holder to clamp the substrate to the substrate holder, wherein the DC voltage ranges from approximately −2000 V. to approximately +2000 V.

23. The method as claimed in claim 1, wherein the depositing of the TERA layer further comprises:
depositing a top portion of the TERA layer during a deposition time, wherein the top portion comprises a material having a refractive index (n) ranging from approximately 1.5 to approximately 2.5 when measured at a wavelength of at least one of: 248 nm, 193 nm, and 157 nm, and an extinction coefficient (k) ranging from approximately 0.10 to approximately 0.9 when measured at a wavelength of at least one of: 248 nm, 193 nm, and 157 nm.

24. The method as claimed in claim 23, wherein the plasma source includes an RF source and the depositing of the top portion further comprises:
operating the RF source in a frequency range from approximately 0.1 MHz. to approximately 200 MHz; and
operating the RF source in a power range from approximately 10.0 watts to approximately 10000 watts.

25. The method as claimed in claim 23, wherein the depositing of the top portion occurs at a rate from approximately 10 A/min to approximately 5000 A/min.

26. The method as claimed in claim 23, wherein the deposition time is within the range from approximately 5 seconds to approximately 200 seconds.

27. The method as claimed in claim 23, wherein the top layer is deposited by providing the processing gas, the processing gas comprising a precursor that includes silicon, carbon and oxygen, and an inert gas.

28. The method as claimed in claim 23, wherein the top layer is deposited by providing the processing gas, the processing gas comprising a silicon-containing precursor, a carbon-containing gas, an oxygen-containing gas, and an inert gas.

29. The method as claimed in claim 27, wherein the precursor is flowed at a rate ranging from approximately 0.0 sccm to approximately 5000 sccm, and the inert gas is flowed at a second rate ranging from approximately 0.0 sccm to approximately 10000 sccm

30. The method as claimed in claim 27, wherein the precursor comprises at least one of: tetramethylcyclotetrasilane (TMCTS) tetraethylorthosilicate (TEOS), dimethyldimethoxysilane (DMDMOS), and octamethylcyclotetrasiloxane (OMCTS).

31. The method as claimed in claim 27, wherein the inert gas comprises at least one of argon, helium, and nitrogen.

32. The method as claimed in claim 28, wherein the processing gas comprises at least one of: monomethylsilane (1MS), dimethylsilane (2MS), trimethylsilane (3MS), and tetramethylsilane (4MS).

33. The method as claimed in claim 32, wherein the depositing of the top portion further comprises:
controlling chamber pressure to be lower than approximately 3 Torr.

34. The method as claimed in claim 33, wherein the depositing of the top portion further comprises:
controlling substrate temperature to be greater than approximately 300° C.

35. The method as claimed in claim 32, wherein the depositing of the top portion further comprises:
controlling substrate temperature to be greater than approximately 300° C.

36. The method as claimed in claim 1, further comprising:
controlling a temperature of the substrate to be in the range from approximately 0° C. to approximately 500° C.

37. The method as claimed in claim 1, further comprising:
controlling the temperature of at least one chamber wall of the chamber.

38. The method as claimed in claim 37, wherein the temperature of the at least one chamber wall ranges from approximately 0° C. to approximately 500° C.

39. The method as claimed in claim 1, wherein a shower plate assembly is coupled to the chamber and the method further comprises:
controlling a temperature of the shower plate assembly.

40. The method as claimed in claim 39, wherein the temperature of the shower plate assembly ranges from approximately 0° C. to approximately 500° C.

41. A method for depositing a material on a substrate, the method comprising:
placing a substrate in a chamber having a plasma source and on a substrate holder;
depositing a first portion of a Tunable Etch Resistant ARC (TERA) layer on the substrate, wherein a first processing gas comprising a first precursor is provided to the chamber; and
depositing a second portion of the TERA layer on the first portion of the TERA layer, wherein a second processing gas comprising a second precursor is provided to the chamber, wherein the second precursor is chosen to reduce reaction with a photoresist.
